(19) United States
(12) Patent Application Publication
(10) Pub. No.: US 2021/0305806 A1
(43) Pub. Date: Sep. 30, 2021

(54) POWER SUPPLY SYSTEM AND POWER SUPPLY METHOD

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Shunsuke KAWACHI, Tama Tokyo (JP); Koji TOBA, Tama Tokyo (JP); Yoko SAKAUCHI, Fuchu Tokyo (JP); Daigo KITTAKA, Yokohama Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 17/345,593

(22) Filed: Jun. 11, 2021

Related U.S. Application Data
(63) Continuation of application No. PCT/JP2018/045807, filed on Dec. 13, 2018.

(51) Int. Cl. H02H 7/10; H02J 3/38; H02J 1/00

(52) U.S. Cl. CPC H02H 7/10; H02J 1/00; H02J 3/38

(57) ABSTRACT

A power supply system according to an embodiment includes at least one or more inverter-connected power sources, a controller, and a current supplier. The inverter-connected power sources are connected to a power transmission line provided in an electric grid. The controller limits, based on output states of the inverter-connected power sources, current output from the inverter-connected power sources to the power transmission line. The current supplier is connected to the power transmission line in parallel with the inverter-connected power sources and when the controller limits the current output of the inverter-connected power sources, outputs a current to the power transmission line.

### CROSS-REFERENCE TO RELATED APPLICATIONS

This application is based upon and claims the benefit of priority from PCT Application No. PCT/JP2018/045807, filed on Dec. 13, 2018; the entire contents of which are incorporated herein by reference.

### FIELD

Embodiments of the present invention relate to a power supply system and a power supply method.

### BACKGROUND

Renewable energy power sources such as by solar power generation and wind power generation are connected to an AC electric grid through a power converter (inverter) in many cases and such power sources are called inverter-connected power sources. In addition, a battery energy storage system which is installed to prevent fluctuations in the output of a renewable energy power source, for example, is also included in the inverter-connected power sources.

If a fault such as a short circuit occurs in the above electric grid, a semiconductor device included in an inverter-connected power source may be broken in a short time due to an over-rated current. Therefore, a power supply system including an inverter-connected power source is provided with an overcurrent protection function for the inverter-connected power source.

When a fault occurs in an electric grid, the fault is dealt with also on the electric grid side by causing a protection system to detect an overcurrent and the like and to perform disconnection of a power transmission line and/or a power distribution line in a fault section.

However, when a fault current flowing toward a fault point at the time of a grid fault is limited by an overcurrent protection function of an inverter-connected power source, the magnitude of the fault current may fall below a fault detection level of the protection system of the electric grid. If a current detection level of the grid protection system is lowered to deal with this problem, an erroneous detection caused by an inrush current of a load or a transformer may occur.

### BRIEF DESCRIPTION OF THE DRAWINGS

FIG. 1 is a block diagram illustrating a configuration of a power supply system according to a first embodiment.

FIG. 2 is a block diagram illustrating a configuration of a power supply system according to a comparative example.

FIG. 3 is a block diagram illustrating a configuration of a power supply system according to a second embodiment.

FIG. 4 is a block diagram illustrating a configuration of a power supply system according to a third embodiment.

### DETAILED DESCRIPTION

Embodiments will now be explained with reference to the accompanying drawings. The present invention is not limited to the embodiments.

A power supply system according to an embodiment includes at least one or more inverter-connected power sources, a controller, and a current supplier. The inverter-connected power sources are connected to a power transmission line provided in an electric grid. The controller limits, based on output states of the inverter-connected power sources, current output from the inverter-connected power sources to the power transmission line. The current supplier is connected to the power transmission line in parallel with the inverter-connected power sources and when the controller limits the current output of the inverter-connected power sources, outputs a current to the power transmission line.

### First Embodiment

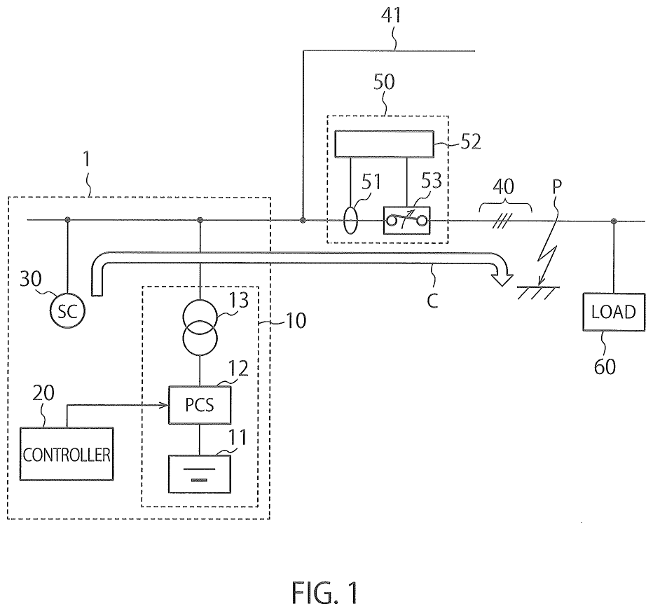

FIG. 1 is a block diagram illustrating a configuration of a power supply system according to a first embodiment. The power supply system 1 illustrated in FIG. 1 includes an inverter-connected power source 10, a controller 20, and a current supplier 30. The power supply system 1 is connected to, for example, a small-scale electric grid installed in an isolated island or the like, that is, a so-called off-grid system. An electric grid illustrated in FIG. 1 is provided with a plurality of power transmission lines 40 and 41, and a protection relay 50. The power transmission line 40 is connected to a load facility 60. The power transmission line 41 branches from the power transmission line 40. The protection relay 50 is provided on a downstream side (side of the load facility 60) of a branch point with the power transmission line 41 on the power transmission line 40; and includes a current detector 51, a switcher 52, and a circuit breaker 53. The current detector 51 detects a current in the power transmission line 40. When a detected current of the current detector 51 exceeds a reference value, the switcher 52 opens the circuit breaker 53. Thus, the power transmission line 40 is disconnected from the power supply system 1 and power is supplied only to the power transmission line 41.

In the power supply system 1 that supplies power to the electric grid, which is described above, the inverter-connected power source 10 includes a DC power source 11, a power converter 12, and a transformer 13. The DC power source 11 outputs a DC power generated by a renewable energy such as by solar power generation or wind power generation or a DC power stored in a lead battery energy storage system, to the power converter 12. In the power converter 12, a semiconductor device such as an insulated gate bipolar transistor (IGBT), for example, performs a switching operation, thereby converting the DC power into an AC power. The transformer 13 transforms voltage of the AC power and performs output to the power transmission line 40 or the power transmission line 41.

In this embodiment, the power supply system 1 includes one inverter-connected power source 10; however, the number of inverter-connected power sources 10 is not limited to one unit. A plurality of inverter-connected power sources 10 that function as current sources or voltage sources may be connected in parallel with each other.

The controller 20 controls, based on the output state of the inverter-connected power source 10, the switching operation of a semiconductor device provided in the power converter 12. The current supplier 30 is connected to the power transmission line 40 in parallel with the inverter-connected power source 10. The current supplier 30 is constituted by a rotating machine such as a synchronous machine or an induction machine.

Hereinafter, the operation of the power supply system 1 according to this embodiment will be described.

In a normal operation, the inverter-connected power source 10 supplies power to the load facility 60 through the power transmission line 40. At this time, the controller 20 controls the switching operation of the semiconductor device of the power converter 12 so as to convert DC power of the DC power source 11, into AC power; and the inverter-connected power source 10 functions as a voltage source that establishes the voltage and frequency of the electric grid. In addition, the current supplier 30 transfers current to and from the power transmission line 40 in synchronization with the voltage and frequency which are established by the inverter-connected power source 10.

In a normal operation, if a fault such as a ground fault or short circuit occurs on the power transmission line 40, an output current of the inverter-connected power source 10 abruptly increases and therefore, an overcurrent flows into the power converter 12 of the inverter-connected power source 10. At this time, the controller 20 detects the overcurrent and controls a gate signal of the semiconductor device in the power converter 12 so as to lower an output voltage of the power converter 12. Thus, the current output from the inverter-connected power source 10 to the power transmission line 40 is limited. Furthermore, if an overcurrent due to the fault is apparent, the switching operation of the power converter 12 is stopped to stop the current output.

When the current output of the inverter-connected power source 10 is limited or stopped, the voltage and frequency of the electric grid are maintained by the current supplier 30 and a fault current C flows toward a fault point P. Since the current supplier 30 is a rotating machine, a current flows through a winding or the like. More specifically, on a current path of the current supplier 30, a semiconductor device does not exist and therefore, the current supplier 30 has higher overcurrent-resistant characteristics than the inverter-connected power source 10. Therefore, the current supplier 30 can supply the fault current C having a magnitude that causes the inverter-connected power source 10 to stop. When this fault current C is detected by the protection relay 50, disconnection of the power transmission line 40 is performed by the circuit breaker 53 of the protection relay 50. As a result, the fault is removed from the electric grid.

When a predetermined period of time has elapsed after an off signal has been input to a gate of the semiconductor device provided in the power converter 12, the controller 20 makes the semiconductor device perform the switching operation again and therefore, the current output of the inverter-connected power source 10 resumes. Since the inverter-connected power source 10 is restored in synchronization with the voltage and frequency of the current supplier 30, power supply to the sound power transmission line 41 in the electric grid is continued. It should be noted that when opening of the circuit breaker 53 is detected, that is, when the power transmission line 40 is disconnected from the current path in the electric grid, the controller 20 may resume the current output of the inverter-connected power source 10.

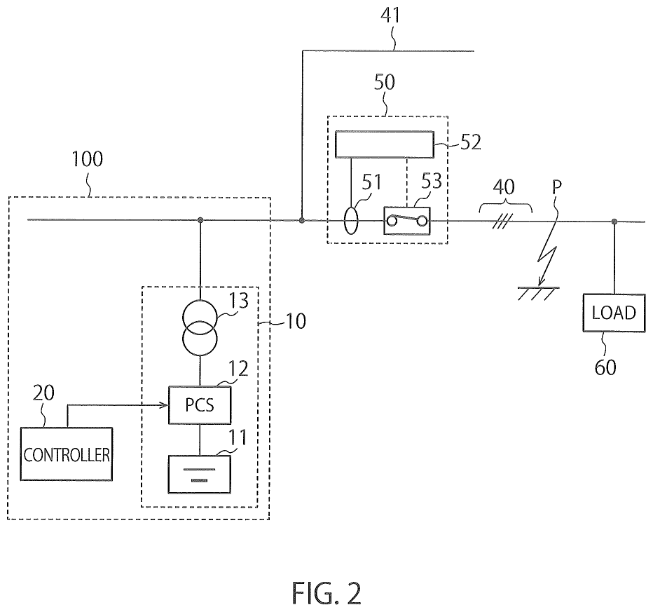

FIG. 2 is a block diagram illustrating a configuration of a power supply system according to a comparative example. The same components as those of the first embodiment described above are denoted by the same reference signs to omit redundant description. The power supply system 100 illustrated in FIG. 2 includes the inverter-connected power source 10 and the controller 20; however, does not include the current supplier 30.

If a fault such as a short circuit occurs in an electric grid which is supplied with power from the power supply system 100, a fault current attempts to flow from the inverter-connected power source 10 toward a fault point P. However, by an overcurrent protection function, the controller 20 controls the switching operation of a semiconductor device in the power converter 12 immediately after the fault occurs, so as to limit or stop an output current. This causes the current output of the inverter-connected power source 10 to be limited and thus, an enough fault current for the protection relay 50 to detect the fault cannot be supplied. If the protection relay 50 does not function, the fault in the electric grid is not removed. Therefore, the inverter-connected power source 10 cannot be restored and as a result, a power failure may occur in the whole electric grid.

It can be considered that in the power supply system 100, by lowering a detection level of the fault current for the protection relay 50, the fault in the electric grid is removed. However, there are installed a plurality of protection relays in the electric grid. Therefore, a work of lowering a detection level of a fault current for the whole grid while considering protection coordination between the relays is rather complicated. In addition, by lowering the detection level of the fault current, it is concerned that erroneous detection due to a phenomenon other than a fault, such as harmonics, may increase.

However, according to this embodiment described above, when a fault in the electric grid occurs, an enough fault current C to detect the fault flows from the current supplier 30 through the protection relay 50 even if the controller 20 limits the current output of the inverter-connected power source 10. Therefore, it is possible to ensure fault detection in the electric grid while protecting the inverter-connected power source. As a result, continuous power supply to sound sections in the electric grid is allowed and therefore, a power failure in the whole grid can be prevented.

It should be noted that in the power supply system 1, not only the overcurrent protection function for the inverter-connected power source 10 but also an overcurrent protection function for the current supplier 30 may be provided. In this case, an overcurrent detection level for the current supplier 30 is set to be higher than an overcurrent detection level for the inverter-connected power source 10 and to be within in a range in which a fault current detection level for the protection relay 50 can be ensured. Then, the current supplier 30 can be protected from an overcurrent.

In addition, according to this embodiment, the current supplier 30 is a rotating machine and therefore, an effect of preventing frequency fluctuations in a normal operation can also be obtained due to inertia of the rotating machine. As a result, a stable operation is easily performed even in a grid with wide power fluctuation.

### Second Embodiment

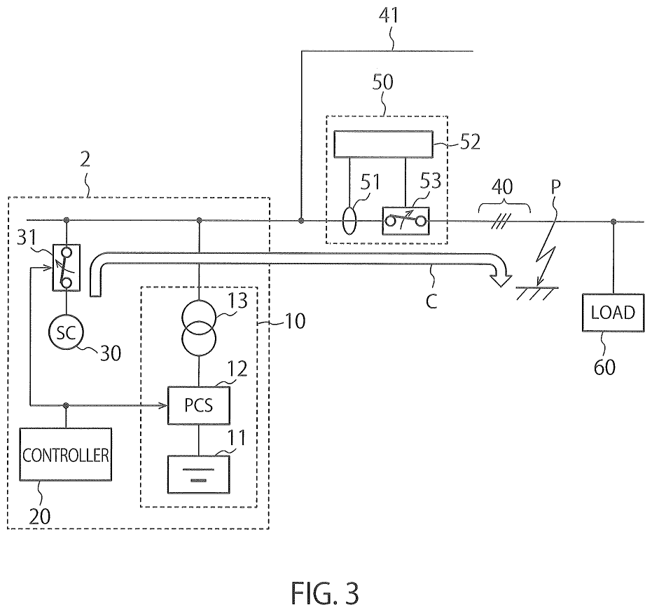

FIG. 3 is a block diagram illustrating a configuration of a power supply system according to a second embodiment. The same components as those of the first embodiment are denoted by the same reference signs to omit redundant description.

As illustrated in FIG. 3, a power supply system 2 according to the second embodiment includes a circuit breaker 31 in addition to the configuration of the first embodiment. The circuit breaker 31 is provided between the current supplier 30 and the power transmission line 40. The circuit breaker 31 is controlled by the controller 20.

Hereinafter, the operation of the power supply system 2 according to this embodiment will be described.

In a normal operation, the inverter-connected power source 10 supplies power to the load facility 60 through the power transmission line 40, as with the first embodiment. At this time, the circuit breaker 31 is closed and therefore, the current supplier 30 outputs a current to the power transmission line 40 in synchronization with a voltage and frequency which are established by the inverter-connected power source 10.

After that, if a fault in the electric grid occurs, the controller 20 limits current output from the inverter-connected power source 10, as with the first embodiment; and therefore, a fault current C is supplied from the current supplier 30.

When the circuit breaker 53 of the protection relay 50 is opened by the fault current C, disconnection of the power transmission line 40 is performed and the fault is removed from the electric grid. When the controller 20 detects switching of the protection relay 50 or detects that a predetermined period of time has elapsed after an off signal has been input to the power converter 12, it transmits a release signal to the circuit breaker 31 and transmits a restoration signal to the power converter 12. As a result, disconnection of the current supplier 30 is performed after the fault in the electric grid has been removed, and at the same time, the inverter-connected power source 10 is restored. Thus, power supply to the power transmission line 40 is substantially continued without instantaneous power interruption.

According to this embodiment described above, when a fault in the electric grid occurs, an enough fault current C to detect the fault flows from the current supplier 30 through the protection relay 50 even if the controller 20 limits the current output of the inverter-connected power source 10, as with the first embodiment. Therefore, it is possible to ensure fault detection in the electric grid while protecting the inverter-connected power source 10.

Furthermore, in this embodiment, after a fault in the electric grid has been removed, disconnection of the current supplier 30 from the electric grid is performed by the circuit breaker 31. This temporarily makes an output voltage of the current supplier 30 volt free. Therefore, even in a case where an output voltage waveform of the current supplier 30 continues to be disturbed after removal of the fault and it is difficult for the inverter-connected power source 10 to be synchronously restored, the inverter-connected power source 10 can be smoothly restored and continue to operate.

For example, in a case where the current supplier 30 is a rotating machine, it is concerned that the rotating energy of the rotating machine is released in accordance with the continuation time of a fault, causing a rotation speed to be lowered and accordingly, the frequency of an output voltage is also lowered. In this case, if the output frequency of the current supplier 30 falls below a lower limit of the output frequency of the inverter-connected power source 10, the inverter-connected power source 10 cannot be restored and a complete power failure in the electric grid occurs. To prevent a power failure in the whole electric grid, it can be considered to increase the inertia of the rotating machine so as to make the rotation speed of the rotating machine difficult to reduce even during the continuation of the fault.

However, such a method leads to an increase in size of the apparatus and in cost therefor. Then, by temporarily performing disconnection of the current supplier 30 that is a rotating machine by the circuit breaker 31 after the fault as in this embodiment, the inverter-connected power source 10 is allowed to continue operating without a concern about a reduction of the output frequency of the current supplier 30 even while the inertia of the rotating machine remains small.

### Third Embodiment

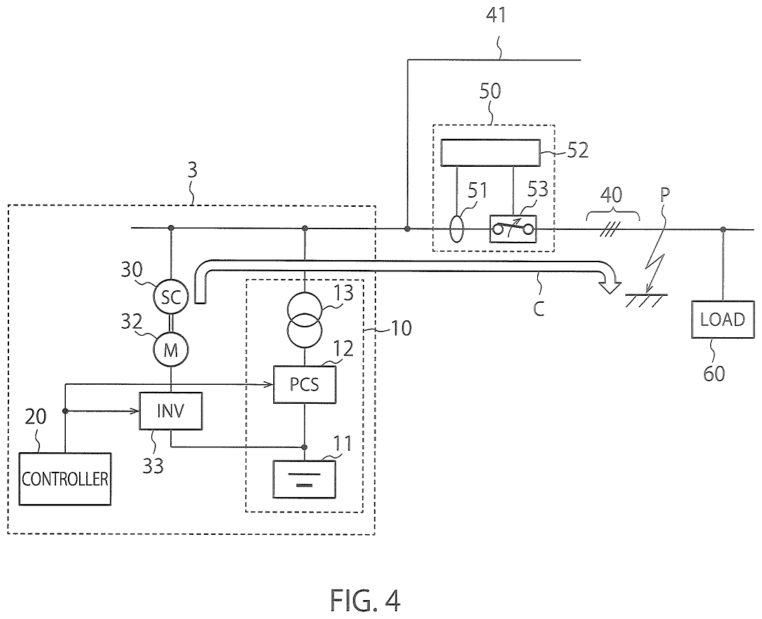

FIG. 4 is a block diagram illustrating a configuration of a power supply system according to a third embodiment. The same components as those of the first embodiment and the second embodiment are denoted by the same reference signs to omit redundant description.

As illustrated in FIG. 4, a power supply system 3 according to the second embodiment includes an electric motor 32 and a power converter 33 in addition to the configuration of the first embodiment. The electric motor 32 drives the current supplier 30. The power converter 33 converts DC power supplied from the DC power source 11, into AC power and supplies it to the electric motor 32, based on control by the controller 20.

Hereinafter, the operation of the power supply system 3 according to this embodiment will be described.

In a normal operation, the inverter-connected power source 10 supplies power to the load facility 60 through the power transmission line 40. At this time, the electric motor 32 drives the current supplier 30 by AC power obtained by conversion by the power converter 33. In this embodiment, the current supplier 30 plays a role of establishing the voltage and frequency of the electric grid; and therefore, the controller 20 can control the inverter-connected power source 10 in either operation mode, a voltage source mode of outputting a constant voltage or a current source mode of outputting a constant current.

Thereafter, if a fault in the electric grid occurs, the controller 20 limits current output from the inverter-connected power source 10, whereas the electric motor 32 continues to drive the current supplier 30. Therefore, a fault current C is supplied from the current supplier 30 to the protection relay 50. After a circuit breaker 53 of the protection relay 50 is opened and a fault point P is disconnected from a current path, the controller 20 causes current output of the inverter-connected power source 10 to be restored. Thus, power supply to the sound power transmission line 41 is continued.

According to this embodiment described above, when a fault in the electric grid occurs, an enough fault current C to detect the fault flows from the current supplier 30 through the protection relay 50 even if the controller 20 limits the current output of the inverter-connected power source 10, as with the first embodiment. Therefore, it is possible to ensure fault detection in the electric grid while protecting the inverter-connected power source 10.

In addition, in this embodiment, the current supplier 30 plays a role of establishing the voltage and frequency of the electric grid in a normal operation. Therefore, the inverter-connected power source 10 does not need to operate as a voltage source. Thus, even when the inverter-connected power source 10 is an inverter-connected power source having only a function as a current source, it is applicable in this embodiment.

Furthermore, since the electric motor 32 is driving the current supplier 30 also during a fault, a disturbance of a voltage waveform due to, for example, a reduction of the frequency of the electric grid hardly occurs and therefore, the inverter-connected power source 10 is easily restored after removal of the fault.

In the above embodiments, description has been made based on a configuration in which power is supplied from a single power supply system to a load facility 60; however, application to a configuration in which power is supplied from a plurality of power supply systems to a plurality of load facilities 60 is also possible. In this case, the power supply systems of the embodiments may be combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A power supply system comprising:
at least one or more inverter-connected power sources that are connected to a power transmission line provided in an electric grid;
a controller that limits current output from the inverter-connected power sources to the power transmission line based on output states of the inverter-connected power sources; and
a current supplier that is connected to the power transmission line in parallel with the inverter-connected power sources and when the controller limits the current output of the inverter-connected power sources, outputs a current to the power transmission line.

2. The power supply system according to claim 1, wherein
the controller resumes the current output of the inverter-connected power sources when a predetermined period of time has elapsed after the current output of the inverter-connected power sources has been limited.

3. The power supply system according to claim 1, wherein
the controller resumes the current output of the inverter-connected power sources when a protection relay provided in the power transmission line performs switching of a current path of the power transmission line.

4. The power supply system according to claim 2, further comprising:
a circuit breaker that is provided between the power transmission line and the current supplier, wherein
the controller resumes the current output of the inverter-connected power sources after making the circuit breaker interrupt an electrical connection between the current supplier and the power transmission line.

5. The power supply system according to claim 1, wherein
the current supplier is a rotating machine; and
the power supply system further comprises an electric motor that drives the rotating machine.

6. A power supply method, comprising:
supplying power from at least one or more inverter-connected power sources to a power transmission line in an electric grid; and
when limiting current output from the inverter-connected power sources to the power transmission line based on output states of the inverter-connected power sources, outputting a current from a current supplier to the power transmission line, the current supplier being connected to the power transmission line in parallel with the inverter-connected power sources.
